(19) United States
(12) Patent Application Publication
(10) Pub. No.: US 2005/0186106 A1
(43) Pub. Date: Aug. 25, 2005

(54) Organic electroluminescent device and process for preparing the same

(75) Inventors: Jian Li, Hirakata-city (JP); Takeshi Sano, Hirakata-city (JP); Yasuko Hirayama, Hirakata-city (JP); Taiji Tomita, Neyagawa-city (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/055,635

(22) Filed: Feb. 11, 2005

(30) Foreign Application Priority Data
Feb. 24, 2004 (JP) 2004-48587

(51) Int. Cl. B32B 27/16; B32B 27/18; B32B 27/30; B05D 5/12

(52) U.S. Cl. 420/500; 428/411.1; 427/66

(57) ABSTRACT

An organic electroluminescent device comprising a pair of electrodes, and a first organic layer and a second organic layer disposed between electrodes, the first organic layer and the second organic layer being formed by coating a solution, the second organic layer being formed on the first organic layer, wherein the first organic layer contains a polymer having carrier transporting property or light emitting property, and a low-molecular crosslinking agent having a functional group, and the low-molecular corsslinking agent is crosslinked in the first organic layer.

The priority Japanese Patent Application Number 2004-48587 upon which this patent application is based is hereby incorporated by reference.

### BACKGROUND OF THE INVENTION

1. Field of the Invention

The present invention relates to an organic electroluminescent device and a process for preparing the same.

2. Description of the Related Art

Since an organic electroluminescent device (organic EL device) is easy to be increased in an area as compared with an inorganic electroluminescent device, desired color development is obtained by selecting a light emitting material, and can be driven at a low voltage, application study has been intensively conducted in recent years. In an organic EL device, a plurality layers comprising an organic material such as a light emitting layer and a carrier transporting layer are formed between a pair of electrodes in many cases.

As the previous method of forming an organic material layer, a method such as a vacuum deposition method is used. However, if an organic material layer as a coated film can be formed by coating a solution, a step of manufacturing a device can be simplified. As a problem in the case of formation by laminating a plurality of organic material layers by such the coated film forming method, there is a problem that, when a solution is coated on an organic material layer which is to be a substrate, the substrate is dissolved by a solvent in a solution. As a method of solving this problem, there is contemplated a method of crosslinking a substrate to make it insoluble in a solvent.

Japanese Patent No. 2921382 gazette and JP-A No. 2002-170667 disclose a method of dispersing a carrier transporting material or a light emitting material in a crosslinkable polymer to form a coated film, and crosslinking the coated film. However, in such the method, since the carrier transporting material or the light emitting material is in the state where the material is dispersed in a polymer matrix, there is a problem that better light emitting property is not obtained.

### SUMMARY OF THE INVENTION

An object of the present invention is to provide an organic EL device in which any of an organic layer as a substrate and an organic layer formed thereon can be formed by a method of forming a coated film by coating a solution in an organic EL device having a structure in which a plurality of organic layers are laminated, and which has better light emitting property, and a process for preparing the same.

The present invention is an organic EL device comprising a pair of electrodes, and a first organic layer and a second organic layer disposed between the electrodes, wherein the first organic layer and the second organic layer are a coated film formed by coating a solution, the second organic layer is formed on the first organic layer, the first organic layer contains a polymer having carrier transporting property or light emitting property, and a low-molecular crosslinking agent having a functional group, and the low-molecular crosslinking agent crosslinks the interior of the first organic layer.

In the present invention, the first organic layer which is to be a substrate contains a polymer having carrier transporting property or light emitting property, and a low-molecular crosslinking agent, and the low-molecular crosslinking agent crosslinks the interior of the first organic layer. In the present invention, since a material having carrier transporting property or a light emitting property is a polymer material, it can be a matrix in the first organic layer. For this reason, better carrier transporting property or light emitting property is exhibited. Therefore, an organic EL device having better light emitting property can be obtained.

In the present invention, since the first organic layer is crosslinked by a low-molecular crosslinking agent, a second organic layer to be formed thereon can be formed by the solution coating method.

A polymer used in the present invention is not particularly limited as far as it is a polymer having carrier transporting property or light emitting property. As a polymer, a polymer having a conjugation structure or a non-conjugation structure is preferable and, as a polymer having carrier transporting property or a light emitting property, many conjugated polymers having a conjugation structure are known.

Examples of the conjugation structure in a polymer include polyfluorene, fluorene copolymer, polyphenylenevinylene, phenylene vinylene copolymer, polyphenylene, and phenylene copolymer. In particular, a polymer having a fluorene structure is preferably used in the present invention. Examples of the fluorene structure include the following fluorene structures. 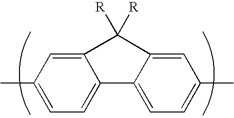
(wherein R is an alkyl group of a carbon number of 1 to 20 optionally containing O, S, N, F, P, Si or an aryl group) 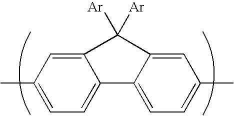
(wherein Ar is the following aryl group) 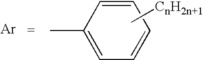
(wherein CₙH₂ₙ₊₁ is an alkyl group of a carbon number of 1 to 20 optionally containing O, S, N, F, P, Si or an aryl group) 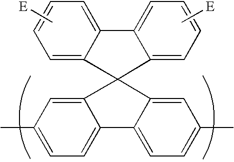
(wherein E is an alkyl group, an aryl group, a phenylamine group, an oxadiazole group or a thiophene group, an alkyl group is the aforementioned alkyl group R of a carbon number of 1 to 20, and an aryl group is the aforementioned Ar)

In the above description, a carbon number of an aryl group is 1 to 20 because when a carbon number is less than 1, a polymer becomes difficult to be dissolved in a solvent and, when a carbon number exceeds 20, carrier transporting property or light emitting property of a polymer is reduced.

A weight average molecular weight (Mw) of a polymer in the present invention is preferably in a range of 500 to 10,000,000, further preferably 1,000 to 5,000,000, particularly preferably 5,000 to 2,000,000. When a molecular weight is too low, property as a polymer such as film forming ability is lost and, when a molecular weight is too high, a polymer becomes difficult to be dissolved in a solvent.

In the present invention, as the low-molecular crosslinking agent contained in the first organic layer, a crosslinking agent which crosslinks the organic layer by ultraviolet-ray irradiation, electron beam irradiation, plasma irradiation or heating is preferably used. A molecular weight of the low-molecular crosslinking agent is preferably 5,000 or lower, further preferably in a range of 15 to 3,000, particularly preferably in a range of 50 to 1000. When a molecular weight is too high, a viscosity of a solution for forming the first organic layer becomes too high, it becomes difficult to form a coated film in some cases. In particular, for forming a coated film with an ink jet, it is preferable that a viscosity is low. In addition, since the low-molecular crosslinking agent is used, diffusion in an organic layer is easy. For this reason, the interior of an organic layer can be uniformly and effectively crosslinked.

It is preferable that the low-molecular crosslinking agent used in the present invention has at least two functional groups. When a functional group is indicated by G, and a molecular skeleton is indicated by R, as the low-molecular crosslinking agent in the present invention, for example, low-molecular crosslinking agents having the following structures are used.

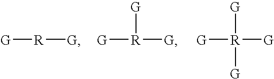

In addition, a crosslinking agent having one functional group shown below may be contained.
R-G

Examples of the molecular skeleton R include molecular skeletons having the following structures.

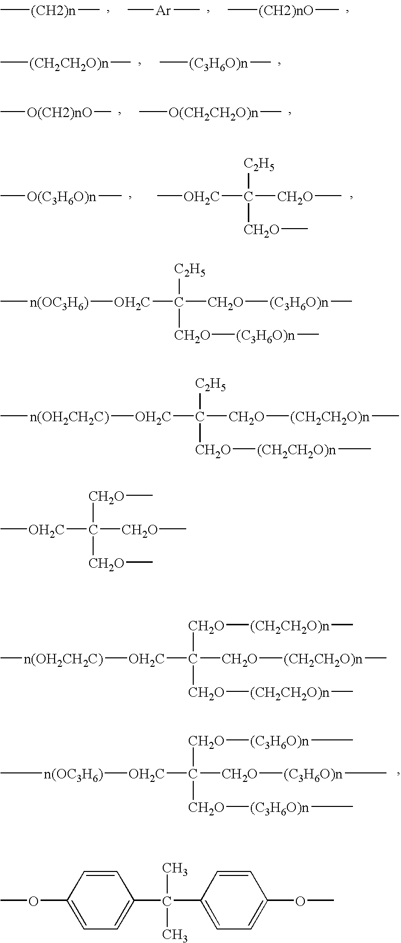

In the case of a crosslinking agent having one functional group, examples of R include hydrogen, an alkyl group, an alkoxy group, an alkylthio group, an alkylsilyl group, an alkylamino group, an aryl group, an aryloxy group, an arylalkyl group, an arylalkoxy group, an arylalkenyl group, an arylalkynyl group, an arylamino group, and a heterocyclic compound group.

Examples of a functional group G include a double bond group, an epoxy group, and a cyclic ether group. Examples of the double bond group include a vinyl group, an acrylate group, and a methacrylate group. The epoxy group may be a glycidyl group. Examples of the cyclic ether group include an oxetane group. Therefore, examples of the functional group G include functional groups having the following structures.

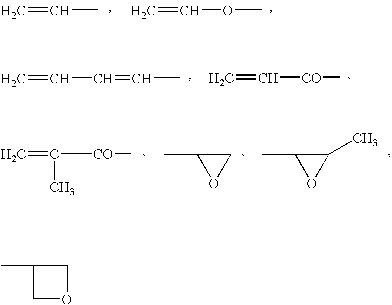

Examples of the low-molecular crosslinking agent in the present invention include divinylbenzene, acrylates, methacrylates, vinyl acetate, acrylonitrile, acrylamide, ethylene glycol diacrylate, ethylene glycol dimethacrylate, ethylene glycol divinyl ether, ethylene glycol diglycidyl ether, ethylene glycol dicyclopentenyl ether acrylate, 1,3-butanediol diacrylate, 1,4-butanediol diacrylate, 1,4-butanediol diglycigyl ether, 1,3-butanediol dimethacrylate, 1,4-butanediol dimethacrylate, 1,4-butanediol divinyl ether, 1,6-hexanediol dicarylate, 1,6-hexanediol dimethacrylate, 1,6-hexanediol divinyl ether, 1,6-hexanediol ethoxylate diacrylate, 1,6-hexanediol propoxylate diacrylate, trimethylolpropane triacrylate, trimethylolpropane triglycidyl ether, trimethylol trimethacrylate, trimethylolpropane ethoxylate methyl ether diacrylate, trimethylolpropane ethoxylate triacrylate, trimethylolpropane propoxylate triacrylate, pentaerythritol tetraacrylate, pentaerythritol tetramethacrylate, bisphenol A diacrylate, bisphenol A dimethacrylate, bisphenol A ethoxylate diacrylate, bisphenol A ethoxylate dimethacrylate, bisphenol A propoxylate diacrylate, bisphenol A propoxylate diglycidyl ether, and bisphenol A dimethacrylate.

In the present invention, a ratio of mixing the polymer and the low-molecular crosslinking agent is such that a content of the low-molecular crosslinking agent relative to the polymer is preferably in a range of 0.1 to 200%. That is, it is preferable that the low-molecular crosslinking agent is 0.1 to 200 parts by weight per 100 parts by weight of the polymer. A content of the low-molecular crosslinking agent relative to the polymer is further preferably 1 to 100% by weight, particularly preferably 3 to 80% by weight. When a content of the low-molecular crosslinking agent becomes too low, crosslinking of the first organic layer becomes insufficient and, upon formation of the second organic layer, the first organic layer is dissolved in some cases. On the other hand, when a content of the low-molecular crosslinking agent is too large, since a content of the polymer becomes relatively small, property such as carrier transporting property or light emitting property is reduced.

In the present invention, in a solution for forming the first organic layer, in addition to the aforementioned polymer and low-molecular crosslinking agent, a solvent for dissolving them may be used. Generally, an organic solvent such as toluene which can dissolve them is used.

In addition, in the present invention, it is preferable that an initiator for initiating a crosslinking reaction of the low-molecular crosslinking agent is contained in a solution for forming the first organic layer. The initiator is selected depending on a functional group of the low-molecular crosslinking agent used. Specifically, a radical polymerization initiator, a photosensitizer, and a cation polymerization initiator are used.

As the radical polymerization initiator, generally known radical polymerization initiators can be used, and examples include peroxide such as benzoyl peroxide, and an azo compound such as azobisisobutyronitrile. Alternatively, a redox initiator may be used.

As the photosensitizer, photosensitizers which are used as a photopolymerization initiator can be used and, when crosslinking is performed by ultraviolet-ray irradiation, an ultraviolet-ray sensitizer is used. Examples of the ultraviolet-ray sensitizer include a carbonyl compound such as benzoin, peroxide such as benzoyl peroxide, an azobis compound such as azobisisobutyronitrile, a sulfur compound such as thiophenol, and a halide such as 2-bromopropane.

As the cation polymerization initiator, protonic acid, metal halide, organometallic compound, organic salt, metal oxide and solid acid, and halogene are used.

A content of the initiator is appropriately adjusted depending on a kind and a content of the low-molecular crosslinking agent, and a kind of the initiator used.

In the present invention, it is preferable that the polymer has a reactive group which reacts with a functional group of the low-molecular crosslinking agent. By using such the polymer having a reactive group, a crosslinking reaction can be effectively caused at a small content of the low-molecular crosslinking agent. Therefore, life properties of an organic EL device can be enhanced.

Examples of the reactive group of the polymer include a double bond group, an epoxy group, and a cyclic ether group.

A process for preparing the organic EL device of the present invention is a process which can prepare the aforementioned organic EL device of the present invention, and comprises a step of coating a solution containing the aforementioned polymer and the aforementioned low-molecular crosslinking agent, a step of crosslinking the low-molecular crosslinking agent in the coated film to form a first organic layer, and a step of coating a solution on the first organic layer to form a second organic layer.

According to the process of the present invention, the first organic layer and the second organic layer can be both formed as a coated film, and an organic EL device having better light emitting property can be prepared.

In the present invention, the first organic layer can be formed as a carrier transporting layer such as a hole injection layer, a hole transporting layer, a light emitting layer, an electron transporting layer, or an electron injection layer. Alternatively, the carrier transporting layer may be a layer called electron blocking layer or hole blocking layer.

The second organic layer in the present invention may be a layer formed on the first organic layer, and can be formed as the aforementioned carrier transporting layer and light emitting layer.

According to the present invention, both of the first organic layer which is to be a substrate, and the second organic layer formed thereon can be formed as a coated film, and an organic EL device having better light emitting property can be obtained.

### BRIEF DESCRIPTION OF THE DRAWINGS

FIG. 1 is a schematic cross-sectional view showing a structure of an organic EL device of Comparative Example.

FIG. 2 is a schematic cross-sectional view showing one example of a structure of an organic EL device in Example of the present invention.

FIG. 3 is a schematic cross-sectional view showing another example of a structure of an organic EL device in Example of the present invention.

FIG. 4 is a view showing results of a life test 1.

FIG. 5 is a view showing results of a life test 2.

FIG. 6 is a view showing HOMO and LUMO of each polymer prepared in Preparation Examples.

FIG. 7 is a schematic view for explaining relationship HOMO and LUMO in a hole transporting layer, a light emitting layer and an electron transporting layer, and electron blocking performance and hole blocking performance.

### DESCRIPTION OF PREFERRED EXAMPLES

The following Examples illustrate the present invention in more detail below, but the present invention is not limited to the following Examples, and can be practiced by appropriate alteration.

### Preparation Example 1

### Preparation of poly[(9,9-dioctylfluorene-2,7-diyl)-alt-(triphenylamine-4,4′-diyl)][polymer 1] (PF8-TPA)

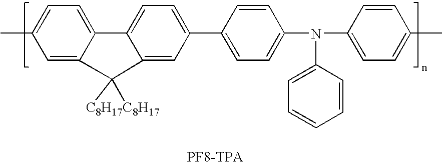

To a reactor equipped with a stirrer, a rubber septa, and an inlet to a vacuum and nitrogen manifold were added 4,4′-dibromotriphenylamine (201.5 mg, 0.5 mmol), 9,9-dioctylfluorene-2,7-bis(4,4,5,5-tetramethyl-1,3,2-dioxoborolane (321 mg, 0.5 mmol), a Suzuki coupling catalyst, 5ml of toluene, and 8ml of an aqueous basic solution. The reactor was evacuated, purged with nitrogen three times, and heated to 90° C. Under the nitrogen atmosphere, the reaction solution was retained at 90° C. for about 3 hours. Then, 61 mg of phenylboric acid was added, and the reactor was further retained at 90° C. for 2 hours under the nitrogen atmosphere. Thereafter, about 0.12 ml of bromobenzene was added, and the reaction solution was retained at 90° C. for 2 hours under the nitrogen atmosphere.

Then, in order to precipitate a polymer, the reaction mixture was poured into 300 ml of methanol, and washed with methanol three times. After dried under vacuum, the polymer was dissolved in about 10 ml of toluene, and this was separated by a column using toluene as an eluent. After a part of the solvent was removed by a rotary evaporator, the polymer solution was added to 300 ml of methanol to obtain precipitates, and washed with methanol three times. Drying under vacuum afforded a white fiber-like product. A yield was about 89%. A number average molecular weight (Mn) was 2.1×10⁴, a weight average molecular weight (Mw) was 5.05×10⁴, and Mw/Mn was 2.60.

### Preparation Example 2

### Preparation of poly[(9,9-dioctylfluorene-2,7-diyl)-alt-(9-butylcarbazole-3,6-diyl)][polymer 2] (PF8-Cz)

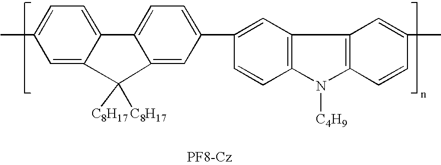

To a reactor equipped with a stirrer, a rubber septa, and an inlet to a vacuum and nitrogen manifold were added 3,6-dibromo-9-butylcarbazole (190.5 mg, 0.5 mmol), 9,9-dioctylfluorene-2,7-bis(4,4,5,5-tetramethyl-1,3,2-dioxoborolane (321 mg, 0.5 mmol), a Suzuki coupling catalyst, 5 ml of toluene, and 8 ml of an aqueous basic solution. The reactor was evacuated, purged with nitrogen three times, and heated to 90° C. Under the nitrogen atmosphere, the reaction solution was retained at 90° C. for about 3 hours.

Then, 61 mg of phenylboric acid was added, and the reactor was further retained at 90° C. for 2 hours under the nitrogen atmosphere. Thereafter, about 0.12 ml of bromobenzene was added, and the reaction solution was retained at 90° C. for 2 hours under the nitrogen atmosphere.

Then, in order to precipitate a polymer, the reaction mixture was poured into 300 ml of methanol, and washed with methanol three times. After dried under vacuum, the polymer was dissolved in about 10 ml of toluene, and this was separated by a column using toluene as an eluent. After a part of the solvent was removed by a rotary evaporator, the polymer solution was added to 300 ml of methanol to obtain precipitates, and washed with methanol three times. Drying under vacuum afforded a white powdery product. A yield was about 89%. A number average molecular weight (Mn) was 3.1×10⁴, a weight average molecular weight (Mw) was 6.8×10⁴, and Mw/Mn was 2.20.

### Preparation Example 3

### Preparation of poly[(9,9-dioctylfluorene-2,7-diyl)-alt-(benzothiadiazole-4,7-diyl)][polymer 3] (PF8-BT)

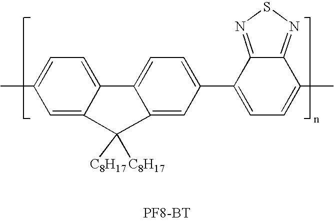

To a reactor equipped with a stirrer, a rubber septa, and an inlet to a vacuum and nitrogen manifold were added 4,7-dibromobenzothiadiazole (147 mg, 0.5 mmol), 9,9-dioctylfluorene-2,7-bis(4,4,5,5-tetramethyl-1,3,2-dioxoborolane (321 mg, 0.5 mmol), a Suzuki coupling catalyst, 5 ml of toluene, and 8 ml of an aqueous basic solution. The reactor was evacuated, purged with nitrogen three times, and heated to 90° C. Under the nitrogen atmosphere, the reaction solution was retained at 90° C. for about 3 hours. Then, 61 mg of phenylboric acid was added, and the reactor was further retained at 90° C. for 2 hours under the nitrogen atmosphere. Thereafter, about 0.12 ml of bromobenzene was added, and the reaction solution was retained at 90° C. for 2 hours under the nitrogen atmosphere.

Then, in order to precipitate a polymer, the reaction mixture was poured into 300 ml of methanol, and washed with methanol three times. After dried under vacuum, the polymer was dissolved in about 10 ml of toluene, and this was separated by a column using toluene as an eluent. After a part of the solvent was removed by a rotary evaporator, the polymer solution was added to 300 ml of methanol to obtain precipitates, and washed with methanol three times. Drying under vacuum afforded a yellow fiber-like product. A yield was about 90%. A number average molecular weight (Mn) was 6.2×10⁴, a weight average molecular weight (Mw) was 1.9×10⁵, and Mw/Mn was 3.20.

### Preparation Example 4

### Preparation of poly[(9,9-dioctylfluorene-2,7-diyl)-alt-(9-butylcarbazole-3,6-diyl)][polymer 4] (PF8-Cz(10%))

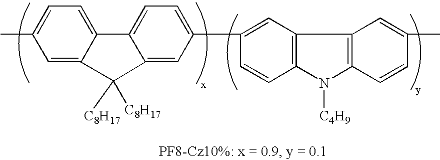

To a reactor equipped with a stirrer, a rubber septa, and an inlet to a vacuum and nitrogen manifold were added 3,6-dibromo-9-butylcarbazole (38.1 mg, 0,1 mmol), 2,7-dibromo-9,9-dioctylfluorene (219 mg, 0.4 mmol), 9,9-dioctylfluorene-2,7-bis(4,4,5,5-tetramethyl-1,3,2-dioxoborolane (321 mg, 0.5 mmol), a Suzuki coupling catalyst, 5 ml of toluene, and 8 ml of an aqueous basic solution. The reactor was evacuated, purged with nitrogen three times, and heated to 90° C. Under the nitrogen atmosphere, the reaction solution was retained at 90° C. for about 3 hours. Then, 61 mg of phenylboric acid was added, and the reactor was further retained at 90° C. for 2 hours under the nitrogen atmosphere. Thereafter, about 0.12 ml of bromobenzene was added, and the reaction solution was retained at 90° C. for 2 hours under the nitrogen atmosphere.

Then, in order to precipitate a polymer, the reaction mixture was poured into 300 ml of methanol, and washed with methanol three times. After dried under vacuum, the polymer was dissolved in about 10 ml of toluene, and this was separated by a column using toluene as an eluent. After a part of the solvent was removed by a rotary evaporator, the polymer solution was added to 300 ml of methanol to obtain precipitates, and washed with methanol three times. Drying under vacuum afforded a gray fiber-like product. A yield was about 92%. A number average molecular weight (Mn) was 2.3×10⁵, a weight average molecular weight (Mw) was 6.4×10⁵, and Mw/Mn was 2.78.

### Preparation Example 5

### Preparation of poly[(9,9-dioctylfluorene-2,7-diyl)-alt-{N,N′-bis(4-tertiary-butylphenyl)-N,N′-diphenylbenzidine-4′,4″-diyl}][polymer 5] (PF8-TPD)

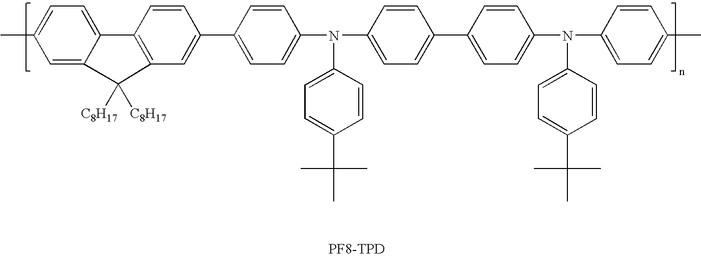

To a reactor equipped with a stirrer, a rubber septa, and an inlet to a vacuum and nitrogen manifold were added N,N′-bis(4-bromophenyl)-N,N′-bis(4-tertiary-butylphenyl)-benzidine (379 mg, 0.5 mmol), 9,9-dioctylfluorene-2,7-bis(4,4,5,5-tetramethyl-1,3,2-dioxoborolane (321 mg, 0.5 mmol), a Suzuki coupling catalyst, 5 ml of toluene, and 8 ml of an aqueous basic solution. The reactor was evacuated, purged with nitrogen three times, and heated to 90° C. Under the nitrogen atmosphere, the reaction solution was retained at 90° C. for about 3 hours. Then, 61 mg of phenylboric acid was added, and the reactor was further retained at 90° C. for 2 hours under the nitrogen atmosphere. Thereafter, about 0. 12 ml of bromobenzene was added, and the reaction solution was retained at 90° C. for 2 hours under the nitrogen atmosphere.

Then, in order to precipitate a polymer, the reaction mixture was poured into 300 ml of methanol, and washed with methanol three times. After dried under vacuum, the polymer was dissolved in about 10 ml of toluene, and this was separated by a column using toluene as an eluent. After a part of the solvent was removed by a rotary evaporator, the polymer solution was added to 300 ml of methanol to obtain precipitates, and washed with methanol three times. Drying under vacuum afforded a gray fiber-like product. A yield was about 92%. A number average molecular weight (Mn) was 6.2×10⁴, a weight average molecular weight (Mw) was 2.3×10⁵, and Mw/Mn was 3.70.

### Preparation Example 6

### Preparation of poly[(9,9-dioctylfluorene-2,7-diyl)-alt-(pyridine-2,6-diyl)][polymer 6] (PF8-Py)

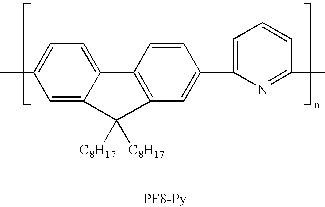

To a reactor equipped with a stirrer, a rubber septa, and an inlet to a vacuum and nitrogen manifold were added 2,6-dibromopyridine (118.5 mg, 0.5 mmol), 9,9-dioctylfluorene-2,7-bis(4,4,5,5-tetramethyl-1,3,2-dioxoborolane (321 mg, 0.5 mmol), a Suzuki coupling catalyst, 5 ml of toluene, and 8 ml of an aqueous basic solution. The reactor was evacuated, purged with nitrogen three times, and heated to 90° C. Under the nitrogen atmosphere, the reaction solution was retained at 90° C. for about 3 hours. Then, 61 mg of phenylboric acid was added, and the reactor was further retained at 90° C. for 2 hours under the nitrogen atmosphere. Thereafter, about 0.12 ml of bromobenzene was added, and the reaction solution was retained at 90° C. for 2 hours under the nitrogen atmosphere.

Then, in order to precipitate a polymer, the reaction mixture was poured into 300 ml of methanol, and washed with methanol three times. After dried under vacuum, the polymer was dissolved in about 10 ml of toluene, and this was separated by a column using toluene as an eluent. After a part of the solvent was removed by a rotary evaporator, the polymer solution was added to 300 ml of methanol to obtain precipitates, and washed with methanol three times. Drying under vacuum afforded a white powdery product. A yield was about 89%. A number average molecular weight (Mn) was 1.2×10⁴, a weight average molecular weight (Mw) was 9.7×10⁴, and Mw/Mn was 7.950.

### Preparation Example 7

### Preparation of poly[(9,9-dioctylfluorene-2,7-diyl)-co-(benzothiadiazol-4,7-diyl)][polymer 7] (PF8-BT(10%))

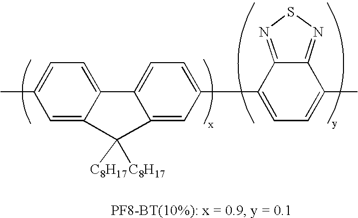

To a reactor equipped with a stirrer, a rubber septa, and an inlet to a vacuum and nitrogen manifold were added 4,7-dibromobenzotihadiazole (29.4 mg, 0.1 mmol), 2,7-dibromo-9,9-dioctylfluorene (219 mg, 0.4 mmol), 9,9-dioctylfluorene-2,7-bis(4,4,5,5-tetramethyl-1,3,2-dioxoborolane (321 mg, 0.5 mmol), a Suzuki coupling catalyst, 5 ml of toluene, and 8 ml of an aqueous basic solution. The reactor was evacuated, purged with nitrogen three times, and heated to 90° C. Under the nitrogen atmosphere, the reaction solution was retained at 90° C. for about 3 hours. Then, 61 mg of phenylboric acid was added, and the reactor was further retained at 90° C. for 2 hours under the nitrogen atmosphere. Thereafter, about 0. 12 ml of bromobenzene was added, and the reaction solution was retained at 90° C. for 2 hours under the nitrogen atmosphere.

Then, in order to precipitate a polymer, the reaction mixture was poured into 300 ml of methanol, and washed with methanol three times. After dried under vacuum, the polymer was dissolved in about 10 ml of toluene, and this was separated by a column using toluene as an eluent. After a part of the solvent was removed by a rotary evaporator, the polymer solution was added to 300 ml of methanol to obtain precipitates, and washed with methanol three times. Drying under vacuum afforded a yellow fiber-like product. A yield was about 89%. A number average molecular weight (Mn) was 1.1×10⁵, a weight average molecular weight (Mw) was 4.4×10⁵, and Mw/Mn was 3.97.

### Preparation Example 8

### Preparation of poly[(9,9-dioctylfluorene-2,7-diyl)-co-{N,N′-bis(4-tertiary-butylphenyl)-N,N′-diphenylbenzidine-4′,4″-diyl}][polymer 8] (PF8-TPD(10%))

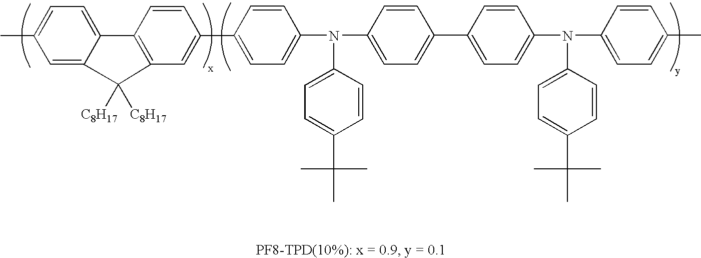

To a reactor equipped with a stirrer, a rubber septa, and an inlet to a vacuum and nitrogen manifold were added N,N′-bis(4-bromophenyl)-N,N′-bis(4-tertiary-butylphenyl)-benzidine (76 mg, 0.1 mmol), 2,7-dibromo-9,9-dioctylfluorene (219 mg, 0.4 mmol), 9,9-dioctylfluorene-2,7-bis(4,4,5,5-tetramethyl-1,3,2-dioxoborolane (321 mg, 0.5 mmol), a Suzuki coupling catalyst, 5 ml of toluene, and 8 ml of an aqueous basic solution. The reactor was evacuated, purged with nitrogen three times, and heated to 90° C. Under the nitrogen atmosphere, the reaction solution was retained at 90° C. for about 3 hours. Then, 61 mg of phenylboric acid was added, and the reactor was further retained at 90° C. for 2 hours under the nitrogen atmosphere. Thereafter, about 0.12 ml of bromobenzene was added, and the reaction solution was retained at 90° C. for 2 hours under the nitrogen atmosphere.

Then, in order to precipitate a polymer, the reaction mixture was poured into 300 ml of methanol, and washed with methanol three times. After dried under vacuum, the polymer was dissolved in about 10 ml of toluene, and this was separated by a column using toluene as an eluent. After a part of the solvent was removed by a rotary evaporator, the polymer solution was added to 300 ml of methanol to obtain precipitates, and washed with methanol three times. Drying under vacuum afforded a gray fiber-like product. A yield was about 92%. A number average molecular weight (Mn) was 1.4×10⁵, a weight average molecular weight (Mw) was 7.5×10⁵, and Mw/Mn was 5.35.

### Preparation Example 9

### Preparation of poly[(2-decyloxybenzene-1,4-diyl)-alt-{N,N′-bis(4-tertiary-butylphenyl)-N,N′-diphenylbenzidine-4′,4″-diyl}][polymer 9] (PPP-TPD)

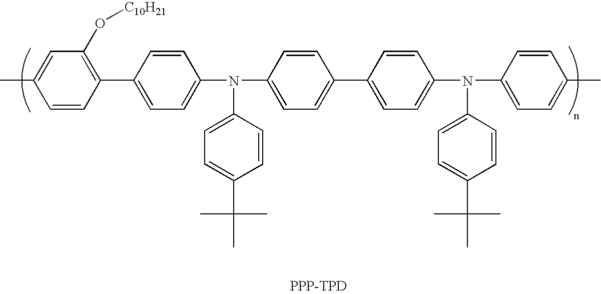

To a reactor equipped with a stirrer, a rubber septa, and an inlet to a vacuum and nitrogen manifold were added N,N′-bis(4-bromophenyl)-N,N′-bis(4-tertiary-butylphenyl)-benzidine (379 mg, 0.5 mmol), 2-decyloxybenzene-1,4-bis(4,4,5,5-tetramethyl-1,3,2-dioxaborolane (486 mg, 0.5 mmol), a Suzuki coupling catalyst, 5 ml of toluene, and 8 ml of an aqueous basic solution. The reactor was evacuated, purged with nitrogen three times, and heated to 90° C. Under the nitrogen atmosphere, the reaction solution was retained at 90° C. for about 3 hours. Then, 61 mg of phenylboric acid was added, and the reactor was further retained at 90° C. for 2 hours under the nitrogen atmosphere. Thereafter, about 0.12 ml of bromobenzene was added, and the reaction solution was retained at 90° C. for 2 hours under the nitrogen atmosphere.

Then, in order to precipitate a polymer, the reaction mixture was poured into 300 ml of methanol, and washed with methanol three times. After dried under vacuum, the polymer was dissolved in about 10 ml of toluene, and this was separated by a column using toluene as an eluent. After a part of the solvent was removed by a rotary evaporator, the polymer solution was added to 300 ml of methanol to obtain precipitates, and washed with methanol three times. Drying under vacuum afforded a white powdery product. A yield was about 68%. A number average molecular weight (Mn) was 1.1×10⁵, a weight average molecular weight (Mw) was 4.5×10⁵, and Mw/Mn was 4.39.

### Preparation Example 10

### Preparation of poly[(9,9-dioctylfluorene-2,7-diyl)-co-(stilbene-4,4′-diyl)][polymer 10] (PF8-SB(10%))

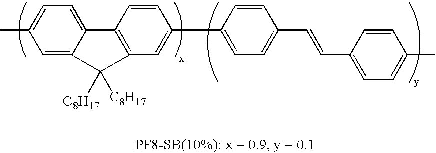

To a reactor equipped with a stirrer, a rubber septa, and an inlet to a vacuum and nitrogen manifold were added 4,4′-dibromo-stilbene (338 mg, 0.1 mmol), 2,7-dibromo-9,9-dioctylfluorene (219 mg, 0.4 mmol), 9,9-dioctylfluorene-2,7-bis(4,4,5,5-tetramethyl-1,3,2-dioxoborolane (321 mg, 0.5 mmol), a Suzuki coupling catalyst, 5 ml of toluene, and 8 ml of an aqueous basic solution. The reactor was evacuated, purged with nitrogen three times, and heated to 90° C.

Under the nitrogen atmosphere, the reaction solution was retained at 90° C. for about 3 hours. Then, 61 mg of phenylboric acid was added, and the reactor was further retained at 90° C. for 2 hours under the nitrogen atmosphere. Thereafter, about 0.12 ml of bromobenzene was added, and the reaction solution was retained at 90° C. for 2 hours under the nitrogen atmosphere.

Then, in order to precipitate a polymer, the reaction mixture was poured into 300 ml of methanol, and washed with methanol three times. After dried under vacuum, the polymer was dissolved in about 10 ml of toluene, and this was separated by a column using toluene as an eluent. After a part of the solvent was removed by a rotary evaporator, the polymer solution was added to 300 ml of methanol to obtain precipitates, and washed with methanol three times. Drying under vacuum afforded a gray fiber-like product. A yield was about 94%. A number average molecular weight (Mn) was 3.3×10⁵, a weight average molecular weight (Mw) was 1.2×10⁶, and Mw/Mn was 3.63.

### Preparation Example 11

### Preparation of poly[(9,9-dioctylfluorene-2,7-diyl)-co-(1,4-distyrylbenzene-4′,4″-diyl)][polymer 11] (PF8-DSB(5%))

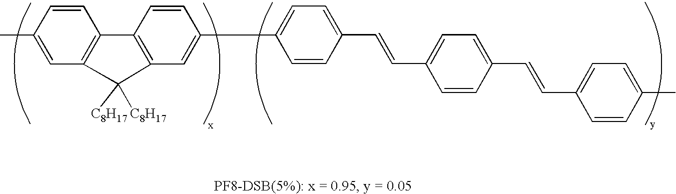

To a reactor equipped with a stirrer, a rubber septa, and an inlet to a vacuum and nitrogen manifold were added 1,4-bis(4-bromophenylvinyl)benzene (22 mg, 0.05 mmol), 2,7-dibromo-9,9-dioctylfluorene (246 mg, 0.45 mmol), 9,9-dioctylfluorene-2,7-bis(4,4,5,5-tetramethyl-1,3,2-dioxoborolane (321 mg, 0.5 mmol), a Suzuki coupling catalyst, 5 ml of toluene, and 8 ml of an aqueous basic solution. The reactor was evacuated, purged with nitrogen three times, and heated to 90° C. Under the nitrogen atmosphere, the reaction solution was retained at 90° C. for about 3 hours. Then, 61 mg of phenylboric acid was added, and the reactor was further retained at 90° C. for 2 hours under the nitrogen atmosphere. Thereafter, about 0.12 ml of bromobenzene was added, and the reaction solution was retained at 90° C. for 2 hours under the nitrogen atmosphere.

Then, in order to precipitate a polymer, the reaction mixture was poured into 300 ml of methanol, and washed with methanol three times. After dried under vacuum, the polymer was dissolved in about 10 ml of toluene, and this was separated by a column using toluene as an eluent. After a part of the solvent was removed by a rotary evaporator, the polymer solution was added to 300 ml of methanol to obtain precipitates, and washed with methanol three times. Drying under vacuum afforded a gray fiber-like product. A yield was about 93%. A number average molecular weight (Mn) was 5.3×10⁵, a weight average molecular weight (Mw) was 2.2×10⁶, and Mw/Mn was 4.15.

### Preparation Example 12

### Preparation of poly(2-methoxy-5-(2-ethylhexyloxy)-1,4-phenylenevinylene)[polymer 12] (MEH-PPV)

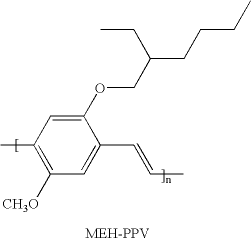

To a reactor equipped with a stirrer, a rubber septa, and an inlet to a vacuum and nitrogen manifold were added 1,4-bischloromethyl-2-methoxy-5-(2-ethylhexyloxy)benzene (335 mg, 1 mmol), and dry THF (10 ml). The reactor was evacuated, purged with nitrogen three times, and retained at room temperature (20° C.). Then, 1120 mg of potassium tertiary butoxide in 10 ml of a dry THF solution was added dropwise to the reactor. A fluorescent solution of red-orange colored MEH-PPV was produced. This solution was retained at room temperature for 24 hours.

Then, in order to precipitate a polymer, the reaction mixture was poured into 300 ml of methanol, and the polymer was washed with methanol three times. Drying under vacuum afforded a red-orange fiber-like product. A yield was about 40%. A number average molecular weight (Mn) was 4.3×10⁵, a weight average molecular weight (Mw) is 2.1×10⁶, and Mw/Mn was 4.88.

### Preparation Example 13

### Preparation of poly[(9,9-dioctylfluorene-2,7-diyl)-co-(benzothiadiazole-4, 7-diyl)-co-{N,N′-bis(4-tertiary-butylphenyl)-N,N′-diphenylbenzidine-4′,4″-diyl}][polymer 13] (PF8-BT(10%)-TPD(10%))

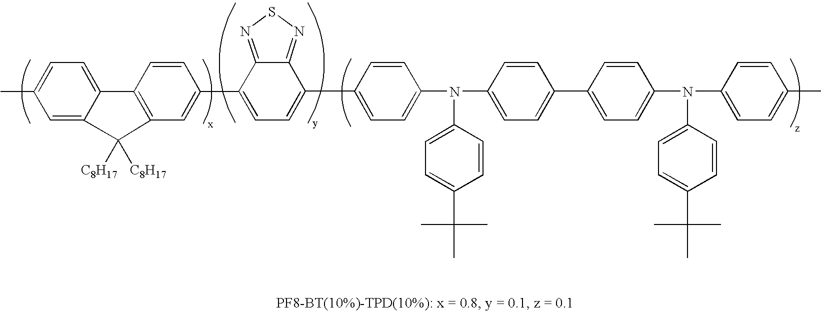

To a reactor equipped with a stirrer, a rubber septa, and an inlet to a vacuum and nitrogen manifold were added N,N′-bis(4-bromophenyl)-N,N′-bis(4-tertiary-butylphenyl)-benzidine (76 mg, 0.1 mmol), 4,7-dibromobenzothidiazole (29.4 mg, 0.1 mmol), 2,7-dibromo-9,9-dioctylfluorene (164.4 mg, 0.3 mmol), 9,9-dioctylfluorene-2,7-bis(4,4,5,5-tetramethyl-1,3,2-dioxoborolane (321 mg, 0.5 mmol), a Suzuki coupling catalyst, 5 ml of toluene, and 8 ml of an aqueous basic solution. The reactor was evacuated, purged with nitrogen three times, and heated to 90° C. Under the nitrogen atmosphere, the reaction solution was retained at 90° C. for about 3 hours. Then, 61 mg of phenylboric acid was added, and the reactor was further retained at 90° C. for 2 hours under the nitrogen atmosphere. Thereafter, about 0.12 ml of bromobenzene was added, and the reaction solution was retained at 90° C. for 2 hours under the nitrogen atmosphere.

Then, in order to precipitate a polymer, the reaction mixture was poured into 300 ml of methanol, and washed with methanol three times. After dried under vacuum, the polymer was dissolved in about 10 ml of toluene, and this was separated by a column using toluene as an eluent. After a part of the solvent was removed by a rotary evaporator, the polymer solution was added to 300 ml of methanol to obtain precipitates, and washed with methanol three times. Drying under vacuum afforded a yellow fiber-like product. A yield was about 91%. A number average molecular weight (Mn) was 2.4×10⁵, a weight average molecular weight (Mw) was 8.5×10⁵, and Mw/Mn was 3.50.

(Crosslinking by Low-Molecular Crosslinking Agent)

In the following Examples 1 to 5, a polymer was crosslinked with a low-molecular crosslinking agent, and a content of a gel was measured. Specifically, a polymer mixture solution was prepared from a polymer, a low-molecular crosslinking agent, a photoinitiator, and toluene, and this was spin-coated on a glass substrate, thereby, a uniform polymer film was formed. The glass substrate on which the polymer film was formed was placed under a UV lump (365 nm, 4 mW/cm²), and the film was irradiated with UV light for a few minutes. A content of a gel in the film was obtained by a difference in UV absorption or a difference in a thickness of the film before and after washing with toluene.

That is, the content of a gel referred herein is a ratio of a polymer film insolubilized by crosslinking, and calculated by a calculating equation of (gel content)=(film thickness of polymer film after crosslinking and washing)÷(film thickness of polymer film before crosslinking).

### Example 1

### Crosslinking of polymer 1 with 1,4-butanediol dimethacrylate

A polymer solution was prepared from the polymer 1 (20 mg), a crosslinking agent (1,4-butanediol dimethacrylate: BDMA) (12 mg), a photoinitiator (benzoin ethyl ether) (0.6 mg) and 5 ml of toluene, and a content of a gel in a polymer film after irradiation with UV light for 5 minutes was measured according to the aforementioned crosslinking method. A content of a gel was 90% or larger.

A structure of BDMA is shown below.

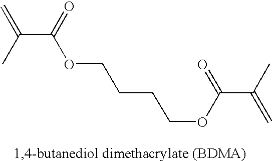

A structure of benzoin ethyl ether is shown below.

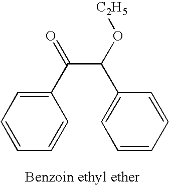

### Example 2

### Crosslinking of polymer 5 with trimethylolpropane trimethacrylate

A polymer solution was prepared from the polymer 5 (20 mg), trimethylolpropane trimethacrylate (5 mg) as a crosslinking agent, benzoin ethyl ether (0.02 mg) as a photoinitiator and 5 ml of toluene and, according to the aforementioned crosslinking method, UV light was irradiated for 3 minutes, and a content of a gel was measured. A content of a gel was 92%.

A structure of trimethylolpropane trimethacrylate is shown below.

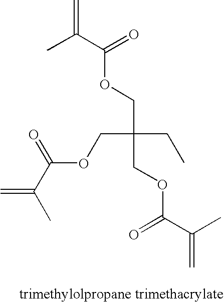

### Example 3

### Crosslinking of polymer 1 with trimethylolpropane trimethacrylate

A polymer solution was prepared from the polymer 1 (20 mg), trimethylolpropane-trimethacrylate (5 mg) as a crosslinking agent, benzoin ethyl ether (0.02 mg) as a photoinitiator and 5 ml of toluene and, according to the aforementioned crosslinking method, UV light was irradiated for about 5 minutes, and a content of a gel was measured. A content of a gel was 52% or larger.

A structure of trimethylolpropane triacrylate is shown below.

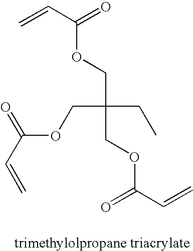

### Example 4

### Crosslinking of polymer 1 with bisphenol a diglycidyl ether

A polymer solution was prepared from the polymer 1 (20 mg), bisphenol A diglycidyl ether (12 mg) as a crosslinking agent, [4-[(2-hydroxytetradecyl)oxy]phenyl]phenyliodonium hexafluoroantimonate (0.6 mg) as a photoinitiator, and 5 ml of toluene and, according to the aforementioned crosslinking method, UV light was irradiated for 5 minutes, and a content of a gel was measured. A content of a gel was 85%.

A structure of bisphenol diglycidyl ether is shown below.

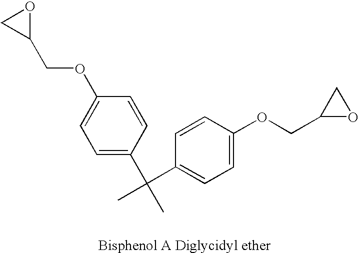

A structure of [4-[(2-hydroxytetradecyl)oxy]phenyl]phenyliodonium hexafluoroantimonate is shown below.

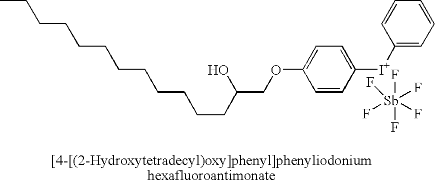

### Example 5

### Crosslinking of polymer 7 with trimethylolpropane trimethacrylate

A polymer solution was prepared from the polymer 7 (20 mg), trimethylolpropane trimethacrylate (4 mg) as a crosslinking agent, benzoin ethyl ether (0.02 mg) as a photoinitiator and 5 ml of toluene and, according to the aforementioned crosslinking method, UV light was irradiated for about 30 seconds, and a content of a gel was measured. A content of a gel was 80% or larger.

(Preparation of Organic EL Device)

In the following Examples and Comparative Examples, an organic EL device was prepared by the following procedure.

A glass substrate in which ITO (indium tin oxide) for a light emitting device had been patterned was washed with ion-exchanged water, 2-propanol and acetone, and all organic molecules on the surface were removed using a UV-ozone stripper to enhance moisture affinity of the surface. Then, an aqueous solution of poly(ethylenedioxythiophene):poly(styrene sulfonate) (hereinafter, referred to as PEDOT: PSS) (manufactured by Bayern) was spin-coated on this ITO substrate to form a hole injecting layer (HIL). A thickness of PEDOT :PSS (PEDOT film: HIL) was controlled at about 400 to 1000 Å, generally at 500 Å. This PEDOT film was heated in an air at about 150 to 280° C., generally at 200° C. for 10 to 30 minutes, and heated in vacuum at 80 to 200° C. or about 30 minutes. Thereafter, a crosslinkable polymer solution was spin-coated on a PEDOT film, and this was crosslinked by UV light irradiation to form a hole transporting layer (HTL) (also referred to as EBL: electron blocking layer). This EBL layer was formed so that a thickness became 100 to 500 Å, generally 200 Å. This HTL layer was not dissolved in any solvent.

After formation of crosslinking of the EBL layer, in order to remove not completely crosslinked low-molecular components or a polymerization initiator, the surface may be washed using a pure solvent (toluene etc.).

Then, a light emitting layer (EML) was formed on an electron arresting layer at a thickness of about 300 to 1200 Å, generally at 600 Å by spin coating. When an electron transporting layer (ETL) was formed, a crosslinkable light emitting polymer solution was used for forming a light emitting layer and, after crosslinking by UV light irradiation, an electron arresting layer was formed on a light emitting layer by spin coating. Then, an electron injecting layer (EIL) composed of calcium, and aluminum (electrode) were deposited in vacuum to form a cathode. A thickness of Ca was 10 to 100 Å, generally 60 Å, and a thickness of Al was 500 to 5000 Å, generally 2000 Å. Finally, in a glow box purged with dry nitrogen, a substrate was covered with a glass cap to obtain a device.

A structure of PEDOT:PSS is shown below.

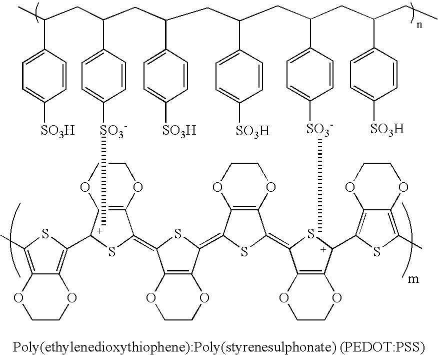

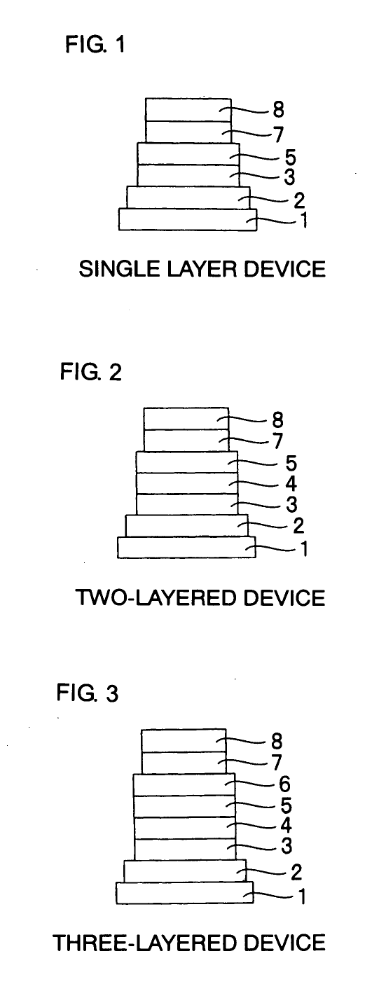

As a structure of an organic EL device, three kinds of structures shown in FIG. 1 to FIG. 3 were prepared. In FIG. 1 to FIG. 3, 1 indicates a glass substrate, 2 indicates a transparent electrode (ITO), 3 indicates a hole injection layer (HIL) composed of PEDOT:PSS, 4 indicates a hole transporting layer (HTL), 5 indicates a light emitting layer (EML), 6 indicates an electron transporting layer (ETL), 7 indicates an electron injecting layer (EIL) composed of Ca or LiF/Ca, and 8 indicates an electrode composed of Al.

FIG. 1 shows a structure of an organic EL device of Comparative Example, and a light emitting layer 5 is provided directly on an electron arresting layer 3.

FIG. 2 shows a structure of an organic EL device of Example, a hole transporting layer 4 is formed on a hole injection layer 3 and, thereafter, a light emitting layer 5 is formed on a hole transporting layer 4. In a device structure shown in FIG. 2, a first organic layer is a hole transporting layer 4, and a second organic layer is a light emitting layer 5.

FIG. 3 shows a structure of an organic EL device of Example, a hole transporting layer 4 is formed on a hole injection layer 3, and a light emitting layer 5 and an electron transporting layer 6 are formed on a hole transporting layer 4. In a device shown in FIG. 3, a hole transporting layer 4 and a light emitting layer 5 correspond to a first organic layer, and an electron transporting layer 6 corresponds to a second organic layer.

Hereinafter, a device having a device structure in FIG. 1 is referred to as “single layer device”, a device having a device structure of FIG. 2 is referred to as “two-layered device”, and a device having a structure shown in FIG. 3 is referred to as “three-layered device”.

### Comparative Example 1

### <Green Emitting Device 1> (Single Layer Device)

Using a polymer 7 (PF8-BT (10%)) for green emitting in the aforementioned preparation of a device, a single layer device was formed. Therefore, a light emitting layer is not crosslinked, and a hole transporting layer and an electron transporting layer are not formed.

### Example 6

### <Green Emitting Device 2> (Two-Layered Device)

In the aforementioned preparation of a device, a polymer 1 (20 mg) and 1,4-butanediol dimethacrylate (12 mg) were dissolved in toluene (5 ml), this solution was coated by spin coating, and this was crosslinked by UV light irradiation to form a hole transporting layer. Thereafter, a polymer 7 for green emitting was used to form a light emitting layer, and a two-layered device was prepared. A light emitting layer is not crosslinked, and an electron transporting layer is not formed.

### Example 7

### <Green Emitting Device 3> (Three-Layered Device)

In the aforementioned preparation of a device, a polymer 1 (20 mg) and 1,4-butanediol dimethacrylate (12 mg) were dissolved in toluene (5 ml), this solution was coated by spin coating, and this was crosslinked by UV light irradiation to form a hole transporting layer. Thereafter, a polymer 7 for green emitting (20 mg) and 1,4-butanediol dimethacrylate (12 mg) were dissolved in toluene (5 ml), this solution was coated by spin coating, this was crosslinked by UV light irradiation to form a light emitting layer, and a polymer 3 was used to form an electron transporting layer.

(Assessment of Device)

Light emitting properties were assessed regarding respective devices of Comparative Example 1 and Examples 6 to 7.

Luminance-current-voltage (L-I-V) properties of respective devices were assessed using the OLED assessment system comprising Topcon BM-5A luminance-color meter, Keithley 2400 digital source meter, and Otsuka Electronics MCPD-7000 multi-channel spectrophotometer controlled by a personal computer.

UV-Vis absorption spectra and photoluminescence spectra of the films were recorded on the Simadzu Miltipec 1500 spectrophotometer and Hitachi F-4500 fluorescence spectrophotometer respectively. Ionization potential was measured with Riken-keiki AC-1 photo-electron spectrometer.

Results of measurement are shown in Table 1.

TABLE 1

| | Driving | | | |
|---|---|---|---|---|
| | Voltage | Max | Max Emitting | Half Life |
| | (at 10 | Luminance | Efficiency | Lifetime |
| Devices | cd/m²(V)) | (cd/m²) | (cd/A) | (hour) |
| Green Emitting | 7.0 | 10113 | 4.33 | 2 |
| Device 1 | | | | (Initiated at |
| | | | | 500 cd/m²) |
| Green Emitting | 5.5 | 15135 | 5.03 | 200 |
| Device 2 | | | | (Initiated at |
| | | | | 500 cd/m²) |
| Green Emitting | 6.5 | 15149 | 3.98 | 240 |
| Device 3 | | | | (Initiated at |
| | | | | 500 cd/m²) |

As apparent from results shown in Table 1, in the green emitting devices in accordance with the present invention, remarkable improvement is recognized in luminance and lifetime. The green emitting device 2 has a lower driving voltage than that of comparative green emitting device 1, and has higher emitting efficiency.

### Example 8

### <Green Emitting Device 4> (Two-Layered Device)

In the aforementioned preparation of a device, a polymer 1 (20 mg), trimethylolpropane triglycidyl ether (4 mg) and [4-[(2-hydroxytetradecyl)oxy]phenyl]phenyliodonium hexafluoroantimonate (0.04 mg) as a photoinitiator were dissolved in toluene (5 ml), this solution was coated by spin coating, and this was crosslinked by UV light irradiation to form an electron arresting layer. A light emitting layer was formed using a green emitting polymer 13.

A driving voltage was about 4V at 10 cd/m², a maximum luminance was about 10840 cd/m² at 13V, and a maximum emitting efficiency was about 3.56 cd/A at 4V and 12 cd/m².

A structure of trimethylolpropane triglycidyl ether is shown below.

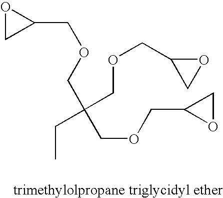

### Example 9

### <Green Emitting Device 4> (Two-Layered Device)

In the aforementioned preparation of a device, a polymer 5 (20 mg), trimethylolpropane triglycidyl ether (4 mg) and [4-[(2-hydroxytetradecyl)oxy]phenyl]phenyliodonium hexafluoroantimonate (0.04 mg) as a photoinitiator were dissolved in toluene (5 ml), this solution was coated by spin coating, and this was corsslinked by UV light irradiation to form a hole transporting layer. A light emitting layer was formed using a green emitting polymer 13.

A driving voltage was about 4.5V at 10 cd/m², a max luminance was about 14461 cd/m² at 13.5V, and a max emitting efficiency was about 3.43 cd/m² at 2.5V and 19 cd/m².

### Comparative Example 2

### <Blue Emitting Device 1> (Single Layer Device)

According to the same manner as that of Comparative Example 1 except that a blue emitting polymer 8 was used, a blue emitting device 1 was prepared.

### Example 10

### <Blue Emitting Device 2> (Two-Layered Device)

According to the same manner as that of Example 6 except that a blue emitting polymer 8 was used in place of a green emitting polymer 7, a blue emitting device 2 was prepared.

### Example 11

### <Blue Emitting Device 3> (Three-Layered Device)

According to the same manner as that of Example 7 except that a polymer 1 (20 mg) and trimethylolpropane trimethacrylate (4 mg) were dissolved in toluene (5 ml), this solution was coated by spin coating, this was crosslinked by UV light irradiation to form a hole transporting layer, a blue emitting polymer 8 (20 mg) and trimethylolpropane trimethacrylate (4 mg) were dissolved in toluene (5 ml), this solution was coated by spin coating, this was crosslinked by UV light irradiation to form a light emitting layer, and a polymer 6 was used to form an electron transporting layer, a blue emitting device 3 was prepared.

(Assessment of Devices)

Blue emitting devices 1 to 3 were assessed as described above, and results of assessment are shown in Table 2.

TABLE 2

| | Driving | | | |
|---|---|---|---|---|
| | Voltage | Max | Max Emitting | Half Life |
| | (at 10 | Luminance | Efficiency | Lifetime |
| Devices | cd/m²(V)) | (cd/m²) | (cd/A) | (hour) |
| Blue Emitting | 4.5 | 5506 | 0.659 | 6.0 |
| Device 1 | | | (at 4178 cd/m²) | |
| Blue Emitting | 5.0 | 6472 | 0.856 | 23 |
| Device 2 | | | (at 5511 cd/m²) | |
| Blue Emitting | 6.5 | 6934 | 1.65 | 20 |
| Device 3 | | | (at 6934 cd/m²) | |

As apparent form results shown in Table 2, it is seen that blue emitting devices 2 and 3 in accordance with the present invention are considerably excellent in max luminance, max emitting efficiency and lifetime as compared with comparative blue emitting device 1.

### Comparative Example 3

### <Red Emitting Device 1> (Single Layer Device)

According to the same manner as that of Comparative Example 1 except that a red emitting polymer 6 (20 mg), bis{2-benzo[b]thiophen-2-yl-pyridinato}iridium acetylacetonato (btp₂Ir(acac)) (2 mg) and TPD (N,N′-bis (3-methylphenyl)-N,N′-diphenylbenzidine) (4 mg) were used to form a light emitting layer in Comparative Example 1, a device was prepared. A hole transporting layer and an electron transporting layer were not formed.

A structure of btp₂Ir(acac) is as shown below.

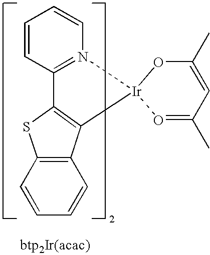

### Example 12

### <Red Emitting Device 2> (Two-Layered Device)

According to the same manner as that of Example 6 except that a polymer 6 (20 mg), btp₂Ir(acac) (2 mg) and TPD (4 mg) were used to form a light emitting layer in Example 6, a device was prepared. A hole transporting layer was formed as in Example 6. An electron transporting layer was not formed.

(Assessment of device)

Red emitting devices 1 and 2 were assessed as described above, and results of assessment are shown in Table 3.

TABLE 3

| | | Max | Max Emitting | Half Life |
|---|---|---|---|---|
| | Driving Voltage | Luminance | Efficiency | Lifetime |
| Devices | (at 10 cd/m²(V)) | (cd/m²) | (cd/A) | (hour) |
| Red | 6 | 1688 | 1.92 | 1.5 |
| Emitting | | (at 12.5 V) | (at 9.0 V, | |
| Device 1 | | | 437 cdA) | |
| Red | 5.5 | 2562 | 3.78 | 1.0 |
| Emitting | | (at 13.0 V) | (at 8.5 V, | |
| Device 2 | | | 388 cd/m²) | |

As apparent from Table 3, the red emitting device 2 in accordance with the present invention is excellent in max luminance and max luminance efficiency. In addition, a driving voltage is reduced.

### Example 13

### <Blue Emitting Device 4> (Two-Layered Device)

A light emitting layer was formed using a blue emitting polymer 4. A hole transporting layer was formed by dissolving a polymer 2 (20 mg) and trimethylolpropane triacryalte (4 mg) in toluene (5 ml), coating this solution by spin coating, and crosslinking this by UV light irradiation. A driving voltage was about 7.5V at 10 cd/m², a max luminance was about 1289 cd/m2, and a max emitting efficiency was about 0.27 cd/A and at 7.5V and 12.8 cd/m².

### Example 14

### <Blue Emitting Device 5> (Two-Layered Device)

A light emitting layer was formed using a blue emitting polymer 10. A hole transporting layer was formed by dissolving a polymer 9 (20 mg) and trimethylolpropane triacrylate (4 mg) in toluene (5 ml), coating this solution by spin coating, and crosslinking this by UV light irradiation. A driving voltage at 10 cd/m² was about 5.5V, a max luminance was about 3215 cd/m², and a max emitting efficiency was about 1.4 cd/A at 668 cd/m² and 7.0V.

### Example 15

### <Orange Emitting Device> (Two-Layered Device)

In this two-layered device, an electron transporting layer was formed on a light emitting layer without forming a hole transporting layer. Therefore, a light emitting layer is a first organic layer, and an electron transporting layer is a second organic layer. A light emitting layer was formed by dissolving an orange emitting polymer 12 (20 mg) and trimethylolpropane triacrylate (4 mg) in toluene (5 ml), coating this solution by spin coating, and crosslinking this by UV light irradiation. An electron transporting layer was formed by using polymer 11. A driving voltage at 10 cd/m² was about 5.0V, a max luminance was about 2325 cd/m², and a max emitting efficiency was about 2.6 cd/A.

### Preparation Example 14

### Preparation of polymer of poly[(9,9-dioctylfluorene-2,7-diyl)-alt-(triphenylamine-4,4′-diyl)] Alternate Copolymer End-Capped with Styrene [polymer 14] (Vinyl-PF8-TPA)

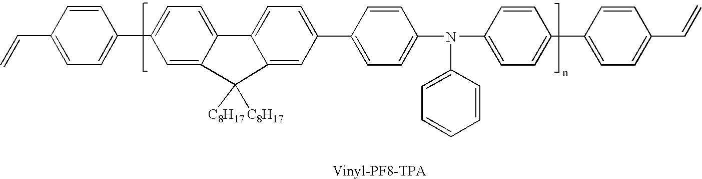

A dry reactor was set with a stirrer, connected to a vacuum/nitrogen line, and capped with a rubber plug and, to the reactor were added 4,4′-dibromotriphenylamine (201.5 mg, 0.5 mmol), 9,9-dioctylfluorene-2,7-bis(4,4,5,5-tetramethyl-1,3,2-dioxaborolane) (240 mg, 0.375 mmol), a Suzuki coupling catalyst, toluene (5 ml) and a basic solution (8 ml). The reactor was degassed-replaced with nitrogen (three times), and the reaction solution was heated to 90° C. while stirring. The reaction solution was retained as it was at 90° C. under the nitrogen atmosphere, and reacted for 3 hours while stirring. Then, vinylphenylboric acid (44.4 mg) was added, and the materials were further reacted at 60° C. under the nitrogen atmosphere while stirring.

Then, the reaction solution mixture was added dropwise to 300 ml of methanol to precipitate a polymer, and the resulting polymer was washed with methanol three times, and dried in vacuum. Thereafter, the polymer was dissolved in about 10 ml of toluene, and this was passed through a column filled with silica gel using toluene as an eluent. A part of the solvent was evaporated to remove from a polymer solution which had passed through a column using a rotary evaporator, and the concentrated polymer solution was added to 300 ml of methanol to precipitate the polymer again. The resulting product was washed with methanol three times, and dried in vacuum to obtain a whitish powdery polymer as a final product. A yield was about 60%. A number average molecular weight (Mn) of this polymer was 7.5×10³, a weight average molecular weight (Mw) was 2.7×10⁴, and Mw/Mn=3.6.

### Example 16

### <Green Emitting Device 6> (Two-Layered Device)

A hole transporting layer was formed by dissolving a polymer 14 (20 mg) and 1,4-butanediol dimethacrylate (12 mg) in toluene (5 ml), coating this solution by spin coating, and crosslinking this by UV light irradiation. A light emitting layer was formed without crosslinking, using a green emitting polymer 7. An electron transporting layer was not formed. A driving voltage at 10 cd/m² was about 4.5V, a max luminance was about 15400 cd/m² at 13V, and a max emitting efficiency was about 3.25 cd/A at 100 cd/m² and 5.5V.

### Preparation Example 15

### Preparation of polymer of poly[(9,9-dioctylfluorene-2,7-diyl)-alt-(triphenylamine-4,4′-diyl)] Alternate Copolymer End-Capped with phenylepoxide [polymer 15] (Epoxide-PF8-TPA)

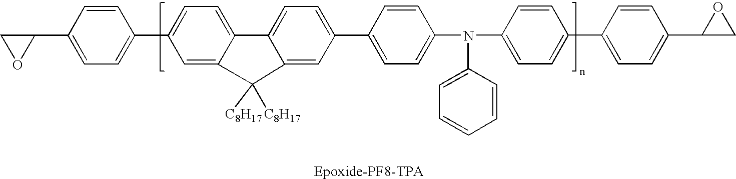

A dry reactor was set with a stirrer, connected to a vacuum/nitrogen line, and capped with a rubber plug and, to the reactor were added 4,4′-dibromotriphenylamine (120.5 mg, 0.3 mmol), 9,9-dioctylfluorene-2,7-bis(4,4,5,5-tetramethyl-1,3,2-dioxaborolane) (289 mg, 0.45 mmol), a Suzuki coupling catalyst, toluene (5 ml) and a basic solution (8 ml). The reactor was degassed-replaced with nitrogen (three times), and the reaction solution was heated to 90° C. while stirring. The reaction solution was retained as it was at 90° C. under the nitrogen atmosphere, and reacted for 3 hours while stirring. Then, 4-bromoepoxidebenzene (72 mg) was added, and the materials were further reacted at 60° C. under the nitrogen atmosphere while stirring.

Then, the reaction solution mixture was added dropwise to 300 ml of methanol to precipitate a polymer, and the resulting polymer was washed with methanol three times, and dried in vacuum. Thereafter, the polymer was dissolved in about 10 ml of toluene, and this was passed through a column filled with silica gel using toluene as an eluent. A part of the solvent was evaporated to remove from a polymer solution which had passed through a column using a rotary evaporator, and the concentrated polymer solution was added to 300 ml of methanol to precipitate the polymer again. The resulting product was washed with methanol three times, and dried in vacuum to obtain a whitish powdery polymer as a final product. A yield was about 58%. A number average molecular weight (Mn) of this polymer was 8.5×10³, a weight average molecular weight (Mw) was 3.0×10⁴, and Mw/Mn was 3.5.

### Example 17

### <Green Emitting Device 7> (Two-Layered Device)

A hole transporting layer was formed by dissolving a polymer 15 (20 mg) and 1,4-butanediol dimethacrylate (12 mg) in toluene (5 ml), coating this solution by spin coating, and crosslinking this by UV light irradiation. A light emitting layer was formed without crosslinking using a green emitting polymer 7. An electron transporting layer was not formed. A driving voltage was about 4V at 10 cd/m², a max luminance was about 13460 cd/m² at 12V, and a max emitting efficiency was about 3.21 cd/A at 100 cd/m² and 5.0V.

### Preparation Example 16

### Preparation of poly[(9,9-dioctenylfluorene-2,7-diyl)-co-(9,9-dioctylfluorene-2,7-diyl)-co-(triphenylamine-4,4′-diyl)]copolymer [polymer 16] {PF(octyl-vinyl)-TPA}

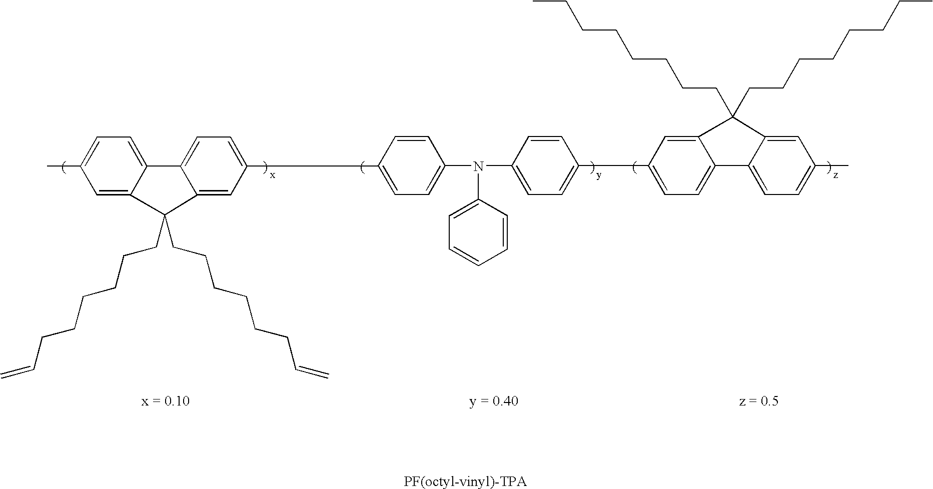

A dry reactor was set with a stirrer, connected to a vacuum/nitrogen line, and a capped with a rubber plug and, to the reactor were added 4,4′-dibromotriphenylamine (160 mg, 0.4 mmol), 2,7-dibromo-9,9-dioctenylfluorene (54.6 mg, 0.1 mmol) 9,9-dioctylfluorene-2,7-bis(4,4,5,5-tetramethyl-1,3,2-dioxaborolane) (321 mg, 0.5 mmol), a Suzuki coupling catalyst, toluene (5 ml), and a basic solution (8 ml). The reactor was degassed-replaced with nitrogen (three times), and the reaction solution was heated to 90° C. while stirring. The reaction solution was retained as it was at 90° C. under the nitrogen atmosphere, and reacted for 3 hours while stirring. Then, phenylboric acid (61 mg) was added, and the materials were further reacted for 60° C. for 2 hours under the nitrogen atmosphere while stirring. Thereafter, bromobenzene (about 0.12 ml) was added, and the reaction solution was retained at 60° C. under the nitrogen atmosphere to further react for 2 hours.

Then, the reaction solution mixture was added dropwise to 300 ml of methanol to precipitate a polymer, and the resulting polymer was washed with methanol three times to dry it in vacuum. Thereafter, the polymer was dissolved in about 20 ml of toluene, and the solution was passed through a column filled with silica gel, using toluene as an eluent. A part of the solvent was evaporated to remove from a polymer solution which had passed through a column using a rotary evaporator, and the concentrated polymer solution was added dropwise to 300 ml of methanol to precipitate the polymer again. The resulting product was washed with methanol three times, and dried in vacuum to obtain a whitish fiber-like polymer as a final product. A yield was about 88%. A number average molecular weight (Mn) of this polymer was 5.3×10⁴, a weight average molecular weight (Mw) was 2.6×10⁵, and Mw/Mn was 4.9.

### Example 18

### <Green Emitting Device 8> (Two-Layered Device)

A polymer 16 (20 mg) and 1,4-butanediol dimethacrylate (12 mg) were dissolved in toluene (5 ml), this solution was coated by spin coating, and this was crosslinked by UV light irradiation to form a hole transporting layer. Then, a polymer 7 having green fluorescent light was formed into a film to obtain a light emitting layer. An electron transporting layer was not formed. Properties of the completed light emitting device were measured, a driving voltage at 10 cd/m² was 4V, a max luminance was 14300 cd/m² at application of 14V, and a max emitting efficiency was 3.15 cd/A (value at 5.5V, 100 cd/m²).

### Preparation Example 17

### Preparation of poly[(9,9-dioctylfluorene-2,7-diyl)-co-{9,9-bis(oxylenylhexyl)fluorene-2,7-diyl}-co-{N,N′-bis(4-tartiary-butylphenyl)-N,N′-diphenylbenzidine-4′,4″-diyl}] copolymer [polymer 17]{PF(octyl-oxirane)-TPD}

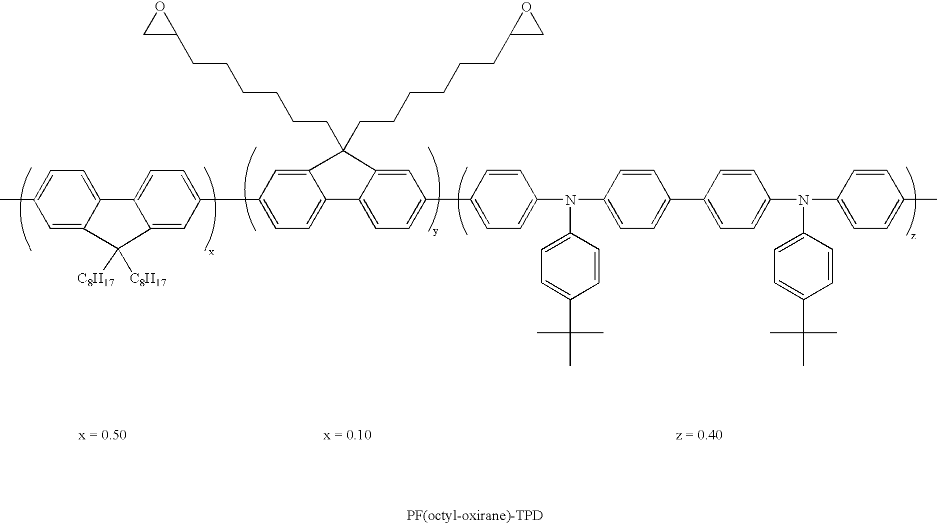

A dry reactor was set with a stirrer, connected to a vacuum/nitrogen line, and capped with a rubber plug and, to the rector were added N,N′-bis(4-bromophenyl)-N,N′-bis(4-tartiary-butylphenyl)benzidine (303.2 mg, 0.40 mmol), 2,7-dibromo-9,9-bis(oxiranylhexyl)fluorene (58 mg, 0.10 mmol), 9,9-dioctylfluorene-2,7-bis(4,4,5,5-tetramethyl-1,3,2-dioxaborolane) (321 mg, 0.50 mmol), a Suzuki coupling catalyst, toluene (5 ml) and a basic solution (8 ml). The reactor was degassed-replaced with nitrogen (three times), and the reaction solution was heated to 90° C. while stirring. The reaction solution was retained as it was at 90° C. under the nitrogen atmosphere, and reacted for 3 hours while stirring. Then, phenylboric acid (61 mg) was added, and the materials were further reacted at 60° C. for 2 hours under the nitrogen atmosphere while stirring. Thereafter, bromobenzene (about 0.12 ml) was added, and the reaction solution was retained at 60° C. under the nitrogen atmosphere while stirring, and further reacted for 2 hours. Then, the reaction solution mixture was added dropwise to 300 ml of methanol to precipitate a polymer, and the resulting polymer was washed with methanol three times, and dried in vacuum. Thereafter, the polymer was dissolved in about 20 ml of toluene, and the solution was passed through a column filled with silica gel, using toluene as an eluent. A part of the solvent was evaporated to remove from the polymer solution which had passed through a column using a rotary evaporator, and the concentrated polymer solution was added to 300 ml of methanol to precipitate the polymer again, The resulting product was washed with methanol three times, and dried in vacuum to obtain a whitish powdery polymer as a final product. A yield was about 86%. A number average molecular weight (Mn) of this polymer was 2.3×10⁴, a weight average molecular weight (Mw) was 8.6×10⁴, and Mw/Mn was 3.7.

### Example 19

### <Green Emitting Device 9> (Two-Layered Device)

A polymer 17 (20 mg) and 1,4-butanediol dimethacrylate (12 mg) were dissolved in toluene (5 ml), this solution was coated by spin coating, and this was crosslinked by UV light irradiation to form a hole transporting layer. Then, a polymer 7 having green fluorescent light was formed into a film without using a crosslinking agent, to obtain a light emitting layer. An electron transporting layer was not used. Properties of the completed light emitting device were measured, a driving voltage at 10 cd/m² was 4V, a max luminance at application of 13.5V was 18300 cd/m², and a max emitting efficiency was 4.15 cd/A (value at 8.5V, 1250 cd/m²)

(Assessment of Devices)

Regarding green emitting devices 6 to 9, a time from an initial luminance of 500 cd/cm² to reduction of luminance by a half was measured using a constant current electric source under the conditions of constant current and dry nitrogen atmosphere. The results are as follows.

TABLE 4

| | Lifetime From Initial Luminance |
|---|---|
| | 500 cd/m² to Reduction in |
| Devices | Luminance by Half (hour) |
| Green Emitting Device 6 | 180 |
| Green Emitting Device 7 | 210 |
| Green Emitting Device 8 | 300 |
| Green Emitting Device 9 | 350 |

As shown in Table 4, although the same light emitting polymer 7 was used, in the case of a green emitting device 1 not using a crosslinked hole transporting layer, a lifetime from an initial luminance of 500 cd/m² to reduction in luminance by a half was only 2 hours. However, in laminated-type light emitting devices having various crosslinked hole transporting layers, a long life could be obtained in all cases. Incidently, when a crosslinking agent is not used, since an underlayer is dissolved, a laminated device can not be formed.

### Preparation Example 18

### Preparation of poly[(9,9-dioctylfluorene-2,7-diyl)-co-(benzothiadiazole-4,7-diyl)-co-(triphenylamine-4,4′-diyl)]

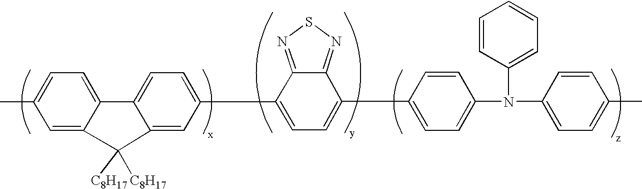

PF8-BT(5%)-TPA(5%) [polymer18] :x=0.90, y=0.05, z=0.05

PF8-BT(5%)-TPA(10%) [polymer 19] :x=0.85, y=0.05, z=0.10

PF8-BT(10%)-TPA(10%) [polymer 20] :x=0.80, y=0.10, z=0.10

PF8-BT(10%)-TPA(15%) [polymer 21] :x=0.75, y=0.10, z=0.15

A dry reactor was set with a stirrer, connected to a vacuum/nitrogen line, and capped with a rubber plug, to the reactor were added 4,7-dibromobenzothiadiazole [(294×y)mg, ymmol], 2,7-dibromo-9,9-dioctylfluorene [{548×(x-0.5)}mg, (x-0.5)mmol], 4,4′-dibromotriphenylamine [(403×z)mg, zmmol], 9,9-dioctylfluorene-2,7-bis(4,4,5,5-tetramethyl-1,3,2-dioxaborolane) (321 mg, 0. 5 mmol), a Suzuki coupling catalyst, toluene (5 ml) and a basic solution (8 ml). The reactor was degassed-replaced with nitrogen (three times), and the reaction solution was heated to 90° C. while stirring. The reaction solution was retained as it was at 90° C under the nitrogen atmosphere, and reacted for about 3 hours while stirring. Then, phenylboric acid (61 mg) was added, and the materials were further reacted at 90° C. for 2 hours under the nitrogen atmosphere while stirring. Thereafter, bromobenzene (about 0.12 ml) was added, the reaction solution was retained at 90° C. under the nitrogen atmosphere while stirring, and further reacted for 2 hours.

Then, the reaction solution mixture was added dropwise to 300 ml of methanol to precipitate a polymer, and the resulting polymer was washed with methanol three times, and dried in vacuum. Thereafter, the polymer was dissolved in about 20 ml of toluene, and the solution was passed through a column filled with silica column, using toluene as an eluent. A part of the solvent was evaporated to remove from a polymer solution which had passed through a column using a rotary evaporator, and the concentrated polymer solution was added dropwise to 300 ml of methanol to precipitate the polymer again. The resulting product was washed with methanol three times, and dried in vacuum to obtain a yellow fiber-like polymer as a final product. A yield was about 85 to 90%. A number average molecular weight (Mn) of these polymers was 2 to 8×10⁴, a weight average molecular weight (Mw) was 5 to 30×10⁴, and Mw/Mn was 2.5 to 5.5.

(Assessment of Light Emitting Device using PF8-BT-TPA Copolymer)

Using a PF8-BT-TPA copolymer as a light emitting material, a light emitting device having a device structure shown below was prepared. A hole transporting layer was crosslinked, and a light emitting layer was not crosslinked. Luminance-current-voltage (L-I-V) properties, and a luminance half life of a device were measured, and compared with green emitting devices 1 and 2.

Device Structure

Green emitting device 10: [ITO/PEDOT:PSS/HTL1/polymer 18/Ca/Al]

Green emitting device 11: [ITO/PEDOT:PSS/HTL1/polymer 19/Ca/Al]

Green emitting device 12: [ITO/PEDOT:PSS/HTL1/polymer 20/Ca/Al]

Green emitting device 13: [ITO/PEDOT:PSS/polymer 20/Ca/Al)]

Green emitting device 14: [ITO/PEDOT:PSS/HTL1/polymer 21/Ca/Al]

(HTL1 was formed by crosslinking a polymer 1 (PF8-TPA) by the method described in Example 1.)

A continuous driving test of a light emitting device was performed under the conditions of room temperature, dry nitrogen atmosphere, constant current, and initial luminance of 500 cd/m², and a change in a luminance and a driving voltage was recorded. Table 5 shows an initial light emitting efficiency, and a time to reduction in a luminance by a half.

TABLE 5

| | | | | | Lifetime From |
|---|---|---|---|---|---|
| | | | TPA | Light Emitting | 500 cd/m² to |
| | Hole | BT Content | Content | Efficiency at | Reduction in |
| | Transporting | (Molar | (Molar | 500 cd/m² | Luminance by |
| Devices | Layer | Fraction) | Fraction) | (cd/A) | Half (hour) |
| Green | Absence | 0.10 | 0 | 4.33 | 2 |
| Emitting 1 | | | | | |
| (Polymer 7) | | | | | |
| Green | Presence | 0.10 | 0 | 5.03 | 200 |
| Emitting 2 | | | | | |
| (Polymer 7) | | | | | |
| Green | Presence | 0.05 | 0.05 | 4.66 | 230 |
| Emitting 10 | | | | | |
| (Polymer 18) | | | | | |
| Green | Presence | 0.05 | 0.10 | 3.68 | 710 |
| Emitting 11 | | | | | |
| (Polymer 19) | | | | | |
| Green | Presence | 0.10 | 0.10 | 4.77 | 750 |
| Emitting 12 | | | | | |
| (Polymer 20) | | | | | |
| Green | Absence | 0.10 | 0.10 | 5.07 | 60 |
| Emitting 13 | | | | | |
| (Polymer 20) | | | | | |
| Green | Presence | 0.10 | 0.15 | 5.30 | 1650 |
| Emitting 14 | | | | | |
| (Polymer 21) | | | | | |

As shown in Table 5, in a laminated-type device using a crosslinked hole transporting layer, a far longer lifetime was obtained as compared with a single layer-type device (green emitting devices 1 and 13) having no hole transporting layer. In addition, a value of a life was changed depending on a composition of a light emitting polymer and, in particular, in a polymer containing TPA which is a phenylamine derivative (polymers 18 to 21), a longer life was shown as compared with a polymer containing PTA (polymer 7). In these polymers, a light emitting component is a BT part, and TPA itself does not contribute to light emitting, but it is considered that a phenylamine derivative has ability to stabilize carrier transporting ability and a hole, and it is thought that it contributes to a longer life. In addition, regarding a content of BT and TPA, a higher light emitting efficiency and a longer life were shown at a BT content higher than 5%. When a BT content approaches 50%, since quenching appears, an optimal content of a light emitting unit is between 5% and 50%. In addition, in the case of the same BT content, a longer life is obtained when a TPA content is higher than a BT content (green emitting device 11>green emitting device) (green emitting device 14>green emitting device 12), and it was seen that, by optimizing a constitution ratio of a light emitting unit and a carrier transporting unit constituting a light emitting polymer, a life can be greatly improved. In the case of this PF8-BT-TPA, an optimal value of a BT unit content is 5 to 25%, and an optimal range of a TPA unit content is 10 to 45%. From the foregoing, it was seen that, when a phenylamine-containing polymer is used in a hole transporting layer, and phenylamine and a copolymer having a light emitting unit are used in a light emitting layer, a very long life can be obtained.

(Life Test 1)

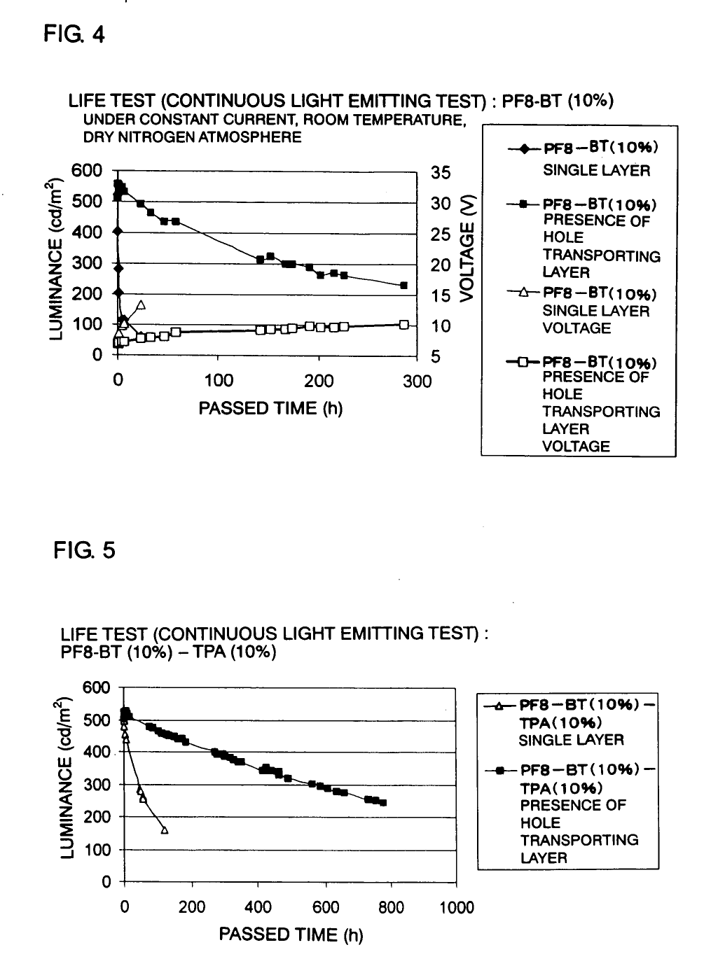

Behavior of a change in a luminance and a driving voltage in a constant current continuous light emitting test of green emitting devices 1 and 2 is shown in FIG. 4. A device 2 using a crosslinked hole transporting layer (HTL) showed a dramatically longer life as compared with a device 1 using no hole transporting layer.

(Life Rest 2)

Behavior of a change in a luminance in a constant current continuous light emitting test of green emitting devices 12 and 13 is shown in FIG. 5. It was seen that a life differs considerably depending on the presence or the absence of a crosslinked hole transporting layer (HTL) like the case of comparison with green emitting devices 1 and 2.

(HOMO and LUMO of Respective Polymers)

Regarding representative polymers among polymers prepared in respective Preparation Examples, a maximum absorption wavelength, HOMO, a band gap, and LUMO are show in Table 6.

TABLE 6

| | λₘₐₓUV | HOMO | Band | |
|---|---|---|---|---|
| Abbreviation | (nm) | (eV) | Gap (eV) | LUMO (eV) |
| PF8-Cz | 345 | −5.41 | 3.07 | −2.34 |
| PF8-TPD(10%) | 383 | −5.34 | 2.94 | −2.4 |
| PF8-TPD | 381 | −5.33 | 2.88 | −2.45 |
| PF8-TPA | 383 | −5.43 | 2.88 | −2.55 |
| PF8-Py | 371 | −5.79 | 3.16 | −2.63 |
| PF8-Cz(10%) | 380 | −5.57 | 2.9 | −2.67 |
| PF8-SB(10%) | 388 | −5.73 | 2.9 | −2.83 |
| PF8-BT(10%)-TPD(10%) | 381 | −5.4 | 2.38 | −3.02 |
| PF8-BT(10%)-TPA(15%) | 378 | −5.46 | 2.39 | −3.07 |
| PF8-BT(10%) | 385 | −5.57 | 2.44 | −3.13 |
| PF8-BT | 471 | −5.88 | 2.36 | −3.52 |

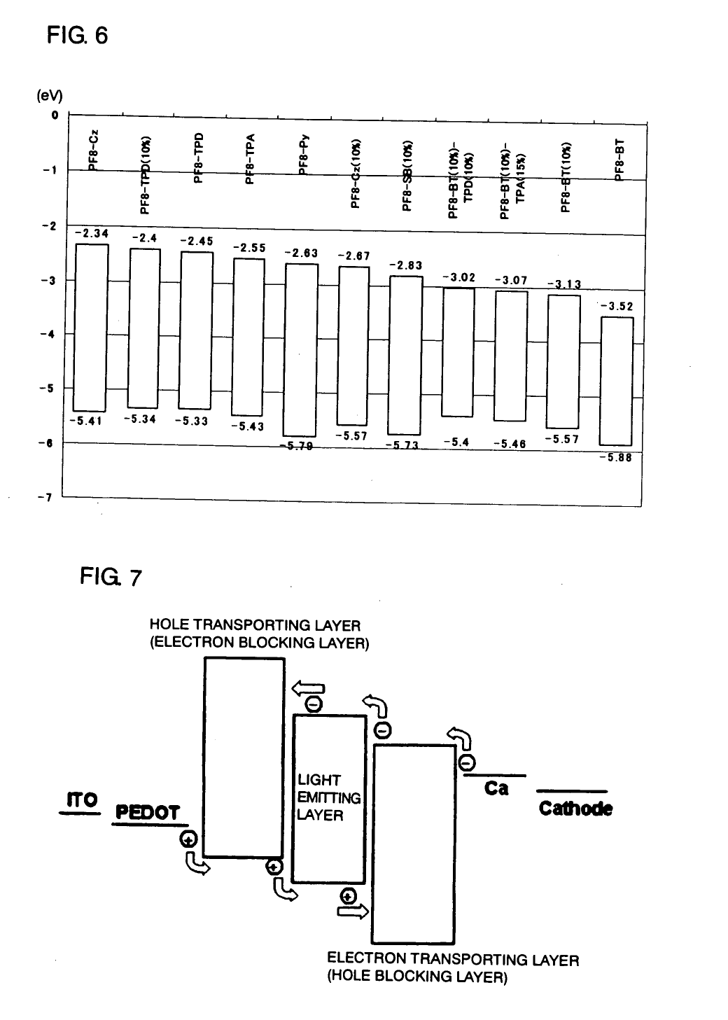

In addition, HOMO and LUMO of respective polymers are schematically shown in FIG. 6.

FIG. 7 is a schematic view for explaining a relationship between LUMO and electron blocking performance, and HOMO and hole blocking performance. As shown in FIG. 7, a higher position of LUMO is excellent in electron blocking performance, and a lower position of HOMO is excellent in hole blocking performance. As shown in FIG. 7, by appropriately combining a hole transporting layer (electron blocking layer), a light emitting layer, and an electron transporting layer (hole blocking layer), a higher light emitting efficiency is obtained.

As shown in Table 6 and FIG. 6, since polymers prepared in the aforementioned Preparation Examples have high LUMO, they are useful as a hole transporting material (electron blocking material) in an organic EL device.

1. An organic electroluminescent device comprising a pair of electrodes, and a first organic layer and a second organic layer disposed between the electrodes, said first organic layer and said second organic layer being formed by coating a solution, said second organic layer being formed on the first organic layer,
wherein said first organic layer contains a polymer having carrier transporting property or light emitting property, and a low-molecular crosslinking agent having a functional group, and said low-molecular corsslinking agent is crosslinked in said first organic layer.

2. The organic electroluminescent device according to claim 1, wherein said low-molecular crosslinking agent is crosslinked by ultraviolet-ray irradiation, electron beam irradiation, plasma irradiation, or heating.

3. The organic electroluminescent device according to claim 1, wherein said functional group of said low-molecular crosslinking agent is a double bond group, an epoxy group, or a cyclic ether group.

4. The organic electroluminescent device according to claim 1, wherein said polymer has a conjugation structure or a non-conjugation structure.

5. The organic electroluminescent device according to claim 4, wherein said conjugation structure is polyfluorene, fluorene copolymer, polyphenylenevinylene, phenylene vinylene copolymer, polyphenylene, phenylene copolymer, polyphenylamine or phenylamine copolymer.

6. The organic electroluminescent device according to claim 4, wherein said non-conjugation structure is polyvinylcarbazole or polyvinylpyridine.

7. The organic electroluminescent device according to claim 1, wherein said polymer has a reactive group which reacts with said functional group of said low-molecular crosslinking agent.

8. The organic electroluminescent device according to claim 7, wherein said reactive group of said polymer is a double bond group, an epoxy group, or a cyclic ether group.

9. The organic electroluminescent device according to claim 1, wherein an initiator for initiating a crosslinking reaction of said low-molecular crosslinking agent is contained in said first organic layer.

10. A process for preparing an organic electroluminescent device as defined in claim 1, which comprises the steps of:
coating a solution containing the polymer and the low-molecular crosslinking agent to form a coated film,
crosslinking the low-molecular crosslinking agent in the coated film to form the first organic layer, and
coating a solution on the first organic layer to form the second organic layer.

11. The process for preparing an organic electroluminescent device according to claim 10, wherein said low-molecular crosslinking agent is crosslinked by ultraviolet-ray irradiation, electron beam irradiation, plasma irradiation, or heating.

12. The process for preparing an organic electroluminescent device according to claim 10, wherein a functional group of said low-molecular crosslinking agent is a double bond group, an epoxy group, or a cyclic ether group.

13. The process for preparing an organic electroluminescent device according to claim 10, wherein said polymer has a conjugation structure or a non-conjugation structure.

14. The process for preparing an organic electroluminescent device according to claim 13, wherein said conjugation structure is polyfluolene, fluorene copolymer, polyphenylenevinylene, phenylene vinylene copolymer, polyphenylene, phenylene copolymer, polyphenylamine or phenylamine copolymer.

15. The process for preparing an organic electroluminescent device according to claim 13, wherein said non-conjugation structure is polyvinylcarbazole or polyvinylpyridine.

16. The organic electroluminescent device according to claim 10, wherein said polymer has a reactive group which reacts with said functional group of said low-molecular crosslinking agent.

17. The process for preparing an organic electroluminescent device according to claim 16, wherein said reactive group of said polymer is a double bond group, an epoxy group, or a cyclic ether group.

18. The process for preparing an organic electroluminescent device according to claim 10, wherein an initiator for initiating a crosslinking reaction of said low-molecular crosslinking agent is contained in said first organic layer.
